(19) United States
(12) Patent Application Publication
(10) Pub. No.: US 2008/0015826 A1
(43) Pub. Date: Jan. 17, 2008

(54) Method And Device Of Predictive Assessment Of Thermal Load For Solid Waste Incineration Plants

(76) Inventor: Jean-Christophe Ealet, La Roque D'Antheron (FR)

Correspondence Address: Jean-Christophe Ealet, 24 bis, avenue de Silvacane, La Roque D'Antheron, F-13640, FR

(21) Appl. No.: 11/578,509

(22) PCT Filed: Sep. 20, 2004
(86) PCT No.: PCT/FR04/02365

§ 371 Date: Oct. 16, 2006

(51) Int. Cl. G06F 17/10

(52) U.S. Cl. 703/2

(57) ABSTRACT

.The invention relates to a method for the predictive assessment of the thermal load generated by solid waste when introduced into incineration furnaces and to the associated device. The invention is based on measuring the air pressure(s) under the first primary air compartment and the temperature(s) of the gases produced upon auto-ignition, said measurements being taken in the first combustion zone located immediately after the feeder that is used to feed the waste into the furnace. The inventive method establishes a relationship between the aforementioned parameters and the steam flow rate which is also measured, said steam being produced by the boiler that is associated with the furnace (or the temperature of the combustion gases) several minutes later during the actual incineration of the waste, resulting from the full combustion thereof at the centre of the furnace. In this way, the difficulty associated with the inertia time between the waste being introduced and the impact of same on the steam flow rate (or of the temperature of the combustion gases) being seen is resolved. Consequently, automatic regulations to equipment can be envisaged in order to control the flow of waste into the solid waste incineration furnace.

This hereby invention relates to a method for the predictive assessment, and its associated device, thermal load generated by solid waste when introduced into incineration furnaces designed for this purpose (push rod grate furnaces, oscillating, with mobile grate, or rolls etc).

By the nature itself of solid waste, of which many physical and chemical characteristics are unknown in real time during their incineration into waste incineration plants, their combustion represents a complex and expensive task. Indeed, neither the chemical composition, neither the water content, neither the lower calorific value, neither grading, neither the specific gravity, nor even the instantaneous waste throughput are known when this waste is introduced into the furnace.

Only a knowledge based on sampling campaigns, carried out over several weeks, by specialized institutes that deliver an average statistical approach of the solid waste characteristics, is available. More, about the incineration process, as it runs continuously during the time, the thermal load value, through steam flow of the boiler associated with the furnace, or combustion gas temperature corrected by total air inlet for the installations not provided with steam generator, is also available. Thus it allows to have an idea of the calorific value mean and waste throughput during the minutes before the waste to be treated is introduced.

However, as the solid waste quantity which will be introduced by the feeder is limited, the product throughput characteristics strongly differ from the average values given by the two previous methods.

Actually, the aforementioned characteristics of solid waste (instantaneous throughput, chemical composition, calorific value, grading etc.) can be considered as random variables, whose only statistical approach was until now undertaken: mean value and standard deviation. The waste throughput introduced at every moment is then a realization of the random variable, on which it is difficult to associate given characteristics.

This is the reason why all of the furnaces control strategies are based on very steady and smoothed feeding speed, with very low and slow variations during the time, to take into account mainly the mean value(s) of the steam flow (or temperature of combustion gases), like incidentally other combustion parameters (temperatures, air duct pressures, oxygen rate in combustion gases measured at the steam generator, rate of other polluting gases etc). For this purpose, they include a set of setting points which matches an furnace control optimum, based on mean incineration process characteristics known while control commissioning. The drawback of this set of setting points is to be difficult and long to establish, to be fragile, and to have a rather reduced operation range.

Thus, if the mean waste throughput and the mean steam flow produced (or temperatures of combustion gases) are well controlled, there are continuous steam flow variations (or temperature of combustion gases variations), specially on small capacity plants (tonnage of waste lower than 10 tons per hour).

These variations bring overdesigns of the incineration plants (furnace, boiler, gas cleaning etc.) in order to be coped with, therefore they bring as well extra investment costs, and generate strong stress on this equipment, which has to run with setting points with strong standard deviation, which impacts its maintenance cost. In the same way, they make the plant commissioning difficult and thus lengthen start-up periods of it. Moreover, the steam is sold to third customers either directly in a form of process steam, or in a form of power generation, and the strong steam flow variability does not allow the plant to optimize the sale contracts of energy.

These variations also make the waste incineration process difficult, generating by-products which may not comply with environment regulations: large quantity of unburnt residues, temperature of combustion gas lower than the current regulations standards, variability which can produce undesirable pollutants etc.

The hereby invention thus enables to bring an original solution to this problem of not-knowledge of the physical and chemical characteristics of the waste introduced at every moment into the incinerator, as soon as it is introduced by the feeder, and thus enables the control of the hereby feeder and the equipment, enabling to control the waste throughput in the furnace, in such manner to limit the range of the steam flow variations (or temperature of combustion gases) and the whole solid waste combustion control parameters of an incineration train.

This invention is then a method of predictive assessment of the thermal load generated by the waste throughput when it is introduced by the feeder, immediately when it enters into the furnace, and this before it does materialize itself by the effective combustion of this quantity of waste, some time after, when the product reaches the effective zone of complete combustion. This anticipated assessment of the thermal load is carried out through the assessment of steam flow generated by the boiler (or temperature of combustion gases), before measuring it (or temperature measurement), after a time corresponding to the waste transit since the introduction of the waste on the grate until it reaches the grate centre, in the combustion area.

This assessment of the steam flow (or temperature of combustion gases), which will be generated by the waste throughput is done by means of a set of temperature and pressure sensors located in the area of waste coming on to the grate of the furnace, area which is right close to the feeder. The pressure sensor(s) is (are) located on the primary air inlet injected in the furnace grate first area (first section of the grate, or first roll). The temperature sensor(s) is (are) located on the low deck of the furnace or the side walls, right close to the first area of the combustion grate. These sensors can thus measure a set of pressure and temperature related to the waste throughput just introduced by the feeder, in the first area of the combustion grate, right close to the feeder.

The pressures of primary air inlet injected under this first area of the grate of the furnace give an image of the product throughput, as well as its grading. These pressures may be corrected by the measured air flows, or be better measured with constant air flow.

The temperatures of gases measured on the low deck of the furnace or the side walls, right close to the first area of the grate of the furnace give a picture of the quality of the product, specially regarding its water content as well as its inflammability. They give also an indirect picture of the product throughput.

The real thermal load of waste will be delivered when the waste gets in full combustion, in the central area of combustion of the grate, zone which succeeds the first area of the grate of the furnace. This thermal load will make the boiler produce a certain steam flow (or temperature of combustion gases), after a certain time, time required for the waste to reach the area of full combustion. The thermal load can be also calculated from the measurement of oxygen (or carbon dioxide) contained in combustion gases, when the combustion air inlet is known or constant.

The invention thus consists in a method which enables to establish a mathematical relation between pressure and temperature measurements, made in the first area of the grate of the furnace, and steam flow measurement (or temperature of combustion gases), raised after a time corresponding to the waste transit since the introduction of it on the grate until it reaches the combustion area.

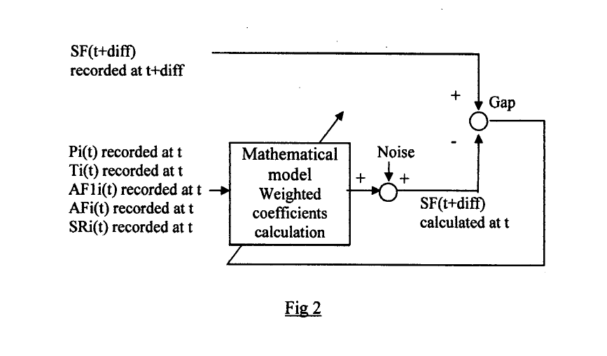

Thus, the invention is a method for the predictive assessment of the thermal load generated by some solid waste when it is introduced by a feeder into incineration furnaces. FIG. 1 is a functional representation of the invention showing the measurements and the points of measurement on an elevation of solid waste incineration furnace. This invention thus breaks up into the following steps (see FIG. 1):

1. Measurement of pressure(s) of the primary air inlet injected under the introduction area of waste on the grate of the furnace (1), part which is right close to the feeder (2), on primary air inlet under the first area of the grate of incineration (3), as close as possible to the feeder (first section of the grate, or first roll).

2. Measurement of temperature of combustion gases on the higher part of the furnace or on the side walls, right close to the introduction area of the waste on the grate of the furnace, part (4) which is right close to the feeder.

3. Measurement of steam flow (or temperature of combustion gases) generated by the boiler (5), after a space of time corresponding to the time necessary for the waste, whose characteristics were measured in 1. and 2., to be introduced and to reach the grate centre, in the combustion area (6).

4. Construction of a mathematical relation between these measurements of pressure, temperature and steam flow (or temperature of combustion gases).

5. The mathematical relation is thus put into practice to the measurements of pressure and temperature carried out in real time during the incineration process, allowing the calculation of an estimated value of the steam flow (or temperature of combustion gases).

Consequently, the estimated value of the steam flow (or temperature of combustion gases) is available as input datum for the combustion control of the incinerator, and especially for the control of the moving parts whose function is the feeding and conveying of the waste, since its introduction into the feed hopper until it is exhausted through the slag remover.

It must be noted that with only measurements of pressure and steam flow (or temperature of combustion gases), or with only the temperature measurements and steam flow (or temperature of combustion gases), degraded mathematical models can be built, leading to predictive assessments whose mean errors are larger than that of the mathematical models based on the couple of data pressure(s)/temperature(s).

The mathematical relation is an addition of the measured pressures and temperatures, weighted by coefficients, whose result is the calculated steam flow (or temperature of combustion gases).

The method also includes an automatic and periodical up-to-date of these coefficients in order to take into account the variations of the model along the time. These variations can come from suddenly changes in the nature itself of solid waste, but also from the variations of the operating conditions of the solid waste incineration plant when the setting points of some parameters influencing the incineration process change: combustion air inlet variation, steam flow variation etc. This up-to-date is carried out by techniques of self-adapting filtering related to signal processing, but can also be obtained by training method, dependent on neural networks, or by empirical methods type fuzzy logic or other. FIG. 2 shows this algorithm, where “Pi” represents the set of pressure measurements, “Ti” the set of the temperature measurements, “SF” steam flow (can be replaced by “TCG”, the temperature of combustion gases), “T” the time variable and “diff” the space of time corresponding to the time of transit of waste since its introduction into the grate area to its arrival in the combustion area.

Thanks to this automatic up-to-date of the coefficients a model of the furnace can be obtained, which compares in real time the computed values of the model with those actually measured, and rectifies on line (see FIG. 2). That gives the model very strong, and very easy to obtain.

The invention takes place in the implementation of the method on the plant digital control system, or in an independent equipment which measures and delivers to the control system the estimated values of the steam flow (or temperature of combustion gases) through standardized signals.

It should also be noted that implementing the method in independent equipment, made up of a data acquisition and computing unit, pressure sensor(s), temperature sensor(s), steam flow sensor (or temperature of combustion gases sensor)in order to measure these values in the way described above (1., 2., and 3.), or interfacing these through a data measurement system, or mixing measurement and interface with a system of measurement of some of these data, allows the manufacturer or the owner of solid waste incinerators to be delivered by this predictive value of the thermal load (flow steam, temperature of combustion gases, oxygen rate or CO2 etc.) without interfering with the incineration process, without modifying the control or the current strategies of control of solid waste incinerators. The implementation of this method with this type of independent equipment makes things easier.

Due to the structure of the aforementioned method, specially the automatic coefficients up-to-date by comparing in real time the value of the predictive estimate of steam flow (or temperature of combustion gases), model output with the real measured steam flow (or temperature of combustion gases), the temperature, pressure and steam flow sensors (or of temperature of combustion gases) do not require strict and scheduled calibrations. The sensors inaccuracies make up for the calculation nature of the weighted coefficients. As a consequence, the equipment implementing the method is durable and has a low-cost maintenance.

1. Method of predictive assessment of the thermal load of a quantity of solid waste when it is introduced by a feeder on the grate inside an incinerator, independent of the incinerator technology (push rod grate furnaces, with rolls, oscillating, rotating or others), characterized by the five following steps:
First step: Measurement of pressure(s) of the primary air inlet under the area where the waste is introduced on the grate of the furnace (FIG. 1, part 1), part which is right close to the feeder (FIG. 1, part 2), on the primary air inlet duct under the first area of the grate of incineration (FIG. 1, part 3), as close as possible to the feeder (first section of the grate, or first roll); these pressures can be possibly corrected by the measured air flows, or even better they can be measured with constant air flow. Measurement of air flow(s) (or air inlet valve(s) position) under the first area of the grate. Measurement of the primary combustion air flow (or air inlet valve position).
Second step: Measurement of temperature of combustion gases on the higher part of the furnace or on the side walls, right close to the area where the waste is introduced on the grate of the furnace, (FIG. 1, part 4) which is right close to the feeder.
Third step: Measurement of steam flow generated by the boiler (FIG. 1, part 5), after a space of time corresponding to the time necessary for the waste, whose characteristics were measured in 1. and 2., to be introduced and to reach the grate centre, in the combustion area (FIG. 1, part 6); Measurement of the speed rate of the first area of the furnace grate (rotation, moving etc.) to determine this space of time. The thermal load finds expression in the measurement of steam flow or of the temperature of combustion gases, but can also be calculated from the measurement of the oxygen rate or the carbon dioxide rate contained in combustion gases, or can be a combination of these various parameters.
Fourth step: Construction of a mathematical relation between these measurements of pressure, temperature, air flow under the first area, primary combustion air flow, speed rate of the first area of the furnace grate and thermal load (in general steam flow or temperature of combustion gases). This mathematical relation is a mathematical model, having weighted coefficients, whose result is the calculated thermal load (steam flow or temperature of combustion gases or oxygen rate or carbon dioxide rate of combustion gases).
Fifth step: Application of the mathematical relation to measurements of pressure, temperature, air flow under the first area, primary combustion air flow, speed rate of the first area of the furnace grate carried out in real time during the process of incineration, allowing an estimated value of the thermal load of the steam flow (in general steam flow or temperature of combustion gases) to be calculated.

2. Method according to claim 1, characterized in what an alternative can be implemented by building a mathematical model simplified with part of measurements, for example with measurements of pressure only, as described in the first step of the first claim, and these of thermal load (in general steam flow or temperature of combustion gases), as described in the third step of the first claim, or with the temperature measurements only, as described in the second step of the first claim and these of thermal load (in general steam flow or temperature of combustion gases), as described in the third step of the first claim.

3. Method according to claims 1 (or 2), characterized in what the weighted coefficients are updated automatically and periodically in order to take into account the variations of the model along the time, which is carried out by comparing in real time the result of the relation with real measurement, and leads to a correction in line of the relation, either through techniques of self-adapting filtering linked to signal processing (FIG. 2), or through training method, linked to neural networks, or even through empirical methods type fuzzy logic or other.

4. Method according to any of claims 1 to 3, characterized in what it leads to provide the estimated value of the thermal load (steam flow or temperature of combustion gases or oxygen rate or carbon dioxide rate of combustion gases), input datum for the combustion control of the incinerator, and especially for the control of the moving parts feeding and conveying the waste, since its introduction into the feed hopper until its evacuation through the slag remover.

5. Device characterized in what it is made of a data acquisition and computing unit, in which the method, according to any of claims 1 to 4, is implemented.
